(19) United States
(12) Patent Application Publication
(10) Pub. No.: US 2008/0192699 A1
(43) Pub. Date: Aug. 14, 2008

(54) Wireless LAN network, and mobile station and method of controlling handoff in the same

(76) Inventor: Seon-Soo Rue, Suwon-si (KR)

Correspondence Address: ROBERT E. BUSHNELL, 1522 K STREET NW, SUITE 300, WASHINGTON, DC, 20005-1202, US

(21) Appl. No.: 12/068,229

(22) Filed: Feb. 4, 2008

(30) Foreign Application Priority Data
Feb. 12, 2007 (KR) 10-2007-0014304

(51) Int. Cl. H04Q 7/00; H04Q 7/24

(52) U.S. Cl. 370/331; 370/338

(57) ABSTRACT

Provided are a wireless local area network (LAN) network, and a mobile station and method of controlling handoff in the wireless LAN network. The method includes the steps of: transmitting and receiving, at a mobile station, a data packet to and from a currently connected first base station using a first antenna; scanning, at the mobile station, an adjacent base station using a second antenna and establishing a link with a second base station detected by the scanning operation; and after establishing, at the mobile station, the new link, comparing communication environments of the first and second base stations and selecting a base station providing a better communication environment. According to the system and method of controlling handoff in a wireless LAN network, a connection with a previous base station can be maintained while establishing a link with a new base station. Consequently, it is possible to prevent packet transmission delay and packet loss that may be caused by handoff.

### CLAIM OF PRIORITY

This application makes reference to, incorporates the same herein, and claims all benefits accruing under 35 U.S.C. §119 from an application for WIRELESS LAN NETWORK, AND MOBILE STATION AND METHOD OF CONTROLLING HANDOFF IN THE SAME earlier filed in the Korean Intellectual Property Office on the 12, Feb. 2007 and there duly assigned Serial No. 10-2007-0014304.

### BACKGROUND OF THE INVENTION

1. Field of the Invention

The present invention relates to a wireless local area network (LAN) network, and a method of controlling handoffs using MIMO (Multi-In Multi-Out) methodology in the wireless LAN network.

2. Description of the Related Art

With the constant development of hardware technology, terminals have become miniaturized and have obtained high performance. In combination with this, wireless packet data networks enable users to obtain useful information regardless of time or place. Such a computing paradigm is based on the core technology which allows a terminal to receive information regardless of its current location, that is, portability of a terminal and wide-ranging mobility of a user. Thus, mobility-supporting technology generally designates a method used for tracking movement of a terminal between different hardware characteristic areas or different mobile communication networks and mutually transmitting location information between network components as occasion demands.

Users of mobile stations must be provided with reliable and stable mobility-supporting technology so that they can enjoy a constant and useful computing environment while watching a multimedia presentation, surfing the Internet, sending email, and so on. In particular, in a wireless LAN environment transmitting high-speed data, an improved mobility-supporting system together with a dynamic load balancing technique can maintain network connections while remote users pass through different access points.

FIG. 1 illustrates a handoff process in a general wireless LAN network.

Referring to FIG. 1, the general wireless LAN network may comprise a plurality of access points 1, 2 and 3 and a mobile host 4 that performs handoff.

The access points 1, 2 and 3 periodically broadcast a beacon message. The broadcast beacon message includes information on the corresponding access points 1, 2 and 3, such as a time stamp, a capability, an Extended Service Set (ESS) identification (ID) and a Traffic Indication Map (TIM).

The mobile host 4 uses the information included in the beacon message to distinguish the different access points 1, 2 and 3 from each other. When a Received Signal Strength (RSS) weakens, the mobile host 4 keeps a beacon message having a higher RSS as a beacon message of a current access point among the adjacent access points 1, 2 and 3.

In an active RSS scanning process, the mobile host 4 transmits a probe request to all the adjacent access points 1, 2 and 3. In response to the probe request, the respective access points 1, 2 and 3 transmit a probe response including periodically broadcast beacon information.

The mobile host 4 selects the access point 3 transmitting the probe response having the highest RSS to determine the access point 3 as a new access point, and transmits a reassociation request to the new access point 3. A message for the reassociation request includes information on the mobile host 4. The new access point 3 transmits a reassociation response including a supporting bit rate, a terminal ID and information required for restarting communication to the mobile host 4. Here, the previous access point 1 is notified of only the reassociation event except a current location of the mobile station 4.

According to the above-described handoff process, since the mobile host 4 has closed a connection with the previous access point 1, packets are lost until a link with the access point 3 is established after movement. A time period from when the mobile host 4 closes the connection to the previous access point 1 until the mobile host 4 establishes a link with the new access point 3 is referred to as an open period. In the open period, data transmission cannot be performed, thus resulting in data loss.

### SUMMARY OF THE INVENTION

It is an object of the present invention to provide a wireless local area network (LAN) network in which a mobile station maintains a connection with a current base station using one of two antennas and performs scanning and link negotiation processes using the other antenna, and the mobile station and a method of controlling handoff in the wireless LAN network.

A first aspect of the present invention provides a wireless LAN network, comprising: a first base station transmitting and receiving a data packet to and from a mobile station existing in an area managed by the first base station; a second base station performing a soft handoff process with the mobile station entering an area managed by the second base station; and the mobile station performing handoff to the second base station while receiving a packet from the previously connected first base station using a Multi-Input Multi-output (MIMO) system.

The mobile station-may comprise: a mobile station transmitter for generating a plurality of symbols corresponding to data to transmit and multiplexing the generated symbols to output the symbols through a plurality of antennas; and a mobile station receiver for receiving symbols in parallel through a plurality of antennas and demodulating the respective received symbols.

The mobile station receiver may include: a link selector for measuring intensities of respective signals received through the plurality of antennas and selecting a base station transmitting the strongest signal from the measured signals; or a sequence checker for checking a sequence of data received from the first and second base stations, and when repeated data is received, dropping the repeated data.

A second aspect of the present invention provides a mobile station in a wireless LAN network, comprising: a mobile station transmitter for generating a plurality of symbols corresponding to data to transmit and multiplexing the generated symbols to output the symbols through a plurality of antennas; and a mobile station receiver for receiving symbols in parallel through a plurality of antennas and demodulating the respective received symbols.

The mobile station transmitter may comprise: an encoder for encoding data received from a Media Access Control (MAC) processor using at least one encoding technique; a Quadrature Amplitude Modulation (QAM) mapper for mapping the bit data encoded by the encoder using a QAM technique to generate a data symbol; a multiplexer for multiplexing a pilot symbol and the data symbol; a plurality of inverse Fourier transformers for receiving and inverse-Fourier-transforming one kind of the multiplexed streams into a time domain; and a radio frequency (RF) processor for RF-processing the signal transformed into the time domain.

The mobile station receiver may comprise: a plurality of RF processors for RF-processing signals received through the plurality of antennas; a plurality of Fourier transformers for Fourier-transforming the RF-processed signals to generate a plurality of data symbols according to the received RF signal; a Receiver (RX) diversity processor for performing a diversity process on the plurality of data symbols; a QAM demapper for demapping the diversity-processed data symbols using a QAM technique to generate a bit stream; and a decoder for decoding the bit stream generated by the QAM demapper according to at least one encoding technique.

The mobile station receiver may further comprise: a link selector for measuring intensities of the respective signals received through the plurality of antennas and selecting a base station transmitting the strongest signal from the measured signals; and a controller for closing a link with an unselected base station.

The mobile station receiver may further comprise: a sequence checker for checking a sequence of data received from a plurality of base stations, and when repeated data is received, dropping the repeated data.

A third aspect of the present invention provides a method of controlling handoff in a wireless LAN network, comprising the steps of: transmitting and receiving, at a mobile station, a data packet to and from a currently connected first base station using a first antenna; scanning, at the mobile station, an adjacent base station using a second antenna and establishing a link with a second base station detected by the scanning operation; and after establishing, at the mobile station, the new link, comparing communication environments of the first and second base stations and selecting a base station providing a better communication environment.

The method may further comprise the step of: closing, at the mobile station, a link with an unselected base station; or dropping one piece of repeated data received from the first and second base station.

When a plurality of base stations are detected by the scanning operation, the mobile station may check communication environments of the plurality of base stations and establish a link with a base station providing the best communication environment.

The mobile station may obtain information on channel state, signal intensity, etc., of the plurality of base stations by transmitting and receiving messages with the plurality of base stations, and compare the communication environments of the plurality of base stations using the obtained information.

### BRIEF DESCRIPTION OF THE DRAWINGS

A more complete appreciation of the invention, and many of the attendant advantages thereof, will be readily apparent as the same becomes better understood by reference to the following detailed description, when considered in conjunction with the accompanying drawings, in which like reference symbols indicate the same or similar components, wherein:

FIG. 1 illustrates a handoff process in a general wireless local area network (LAN) network;

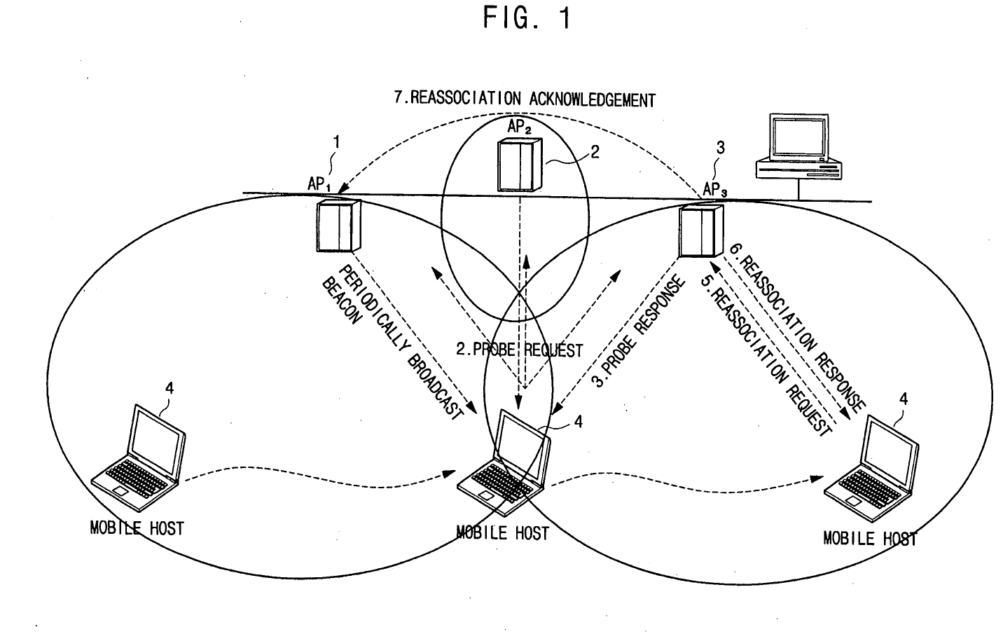

FIG. 2 illustrates a wireless LAN network according to an exemplary embodiment of the present invention;

FIG. 3 is a block diagram of a transmitter of a Multi-Input Multi-Output (MIMO) mobile station according to an exemplary embodiment of the present invention;

FIG. 4 is a block diagram of a receiver of an MIMO mobile station according to an exemplary embodiment of the present invention; and

FIG. 5 is a flowchart showing a method of controlling handoff in a wireless LAN network according to an exemplary embodiment of the present invention.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness. The following description will be made regarding exemplary embodiments in which the present invention is applied to a wireless local area network (LAN) network using a Multi-Input Multi-Output (MIMO) system, and a mobile station and method of controlling handoff in the wireless LAN network. It should be noted that the following exemplary embodiments are merely to help with understanding the present invention, and thus are not to be interpreted as limiting the scope of the present invention.

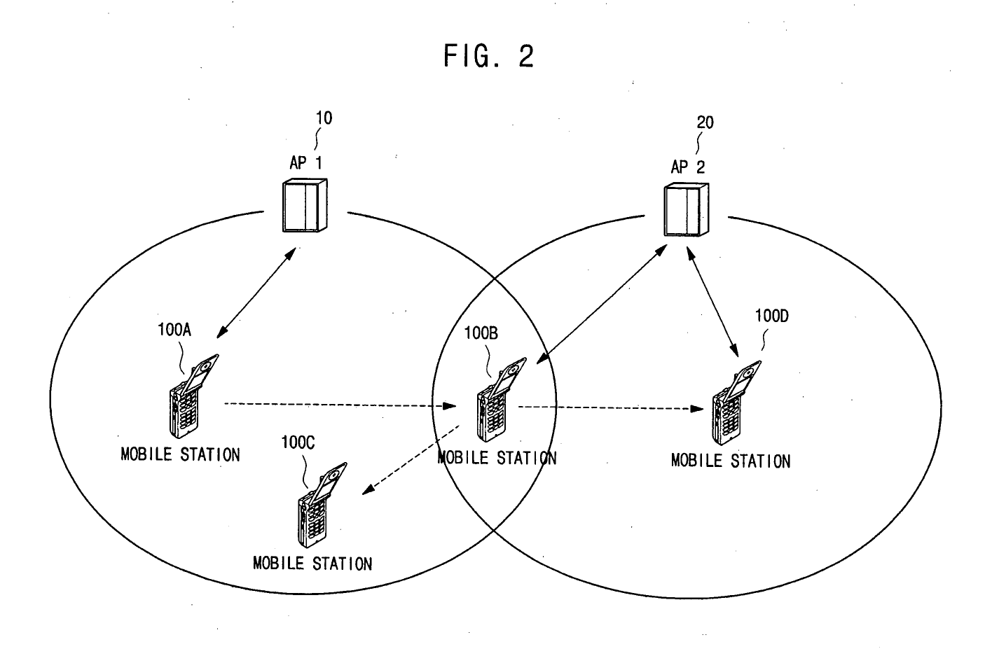

FIG. 2 illustrates a wireless LAN network according to an exemplary embodiment of the present invention.

As illustrated in FIG. 2, the wireless LAN network according to an exemplary embodiment of the present invention may comprise a mobile station 100 using an MIMO system and a plurality of access points 10 and 20 to which the mobile station 100 can perform handoff.

The mobile station 100 functions to scan the access points 10 and 20 adjacent to the mobile station 100 using one of two antennas and establish a new link with the scanned access points 10 and 20. During the link establishment process, the mobile station 100 maintains a connection with the previously connected access point 10 and 20 using the other antenna of the MIMO system, thereby receiving data.

In FIG. 2, the mobile station 100A before movement maintains a connection with the first access point 10 and receives data from the first access point 10. The mobile station 100 enters an area in which it is possible to connect with both the first and second access points 10 and 20. Here, the mobile station in the area after movement is denoted by reference numeral 100B.

In this case, the mobile station 100B scans the second access point 20 and then establishes a new link with the second access point 20 while maintaining the connection with the first access point 10. Such a function can be implemented on the assumption that the mobile station 100 supports MIMO.

Here, unlike a conventional handoff method, the mobile station 100B does not close the link with the first access point 10 immediately after establishing the link with the second access point 20. Rather, the mobile station 100B connects with both the first and second access points 10 and 20 to transmit and receive data. This is for checking later which area of the first and second access points 10 and 20 the mobile station 10B enters. Due to the simultaneous connection, packet loss does not occur during a handoff process, and thus it is possible to more reliably perform an access point selection process.

More specifically, when the mobile station 100B changes its course and again enters an area of the first access point 10 alone, the mobile station 100C closes the connection newly established with the second access point 20. Meanwhile, when the mobile station 100B keeps moving and enters an area of the second access point 20 alone, the mobile station 100D closes the connection with the previously connected first access point 10.

Such a mobile station may comprise a mobile station transmitter and a mobile station receiver. The mobile station transmitter generates a plurality of symbols corresponding to data to transmit and multiplexes the generated symbols to output the symbols through a plurality of antennas. The mobile station receiver receives symbols in parallel through a plurality of antennas and demodulates the respective received symbols. Detailed constitutions of the mobile station transmitter and the mobile station receiver will be described in further detail below.

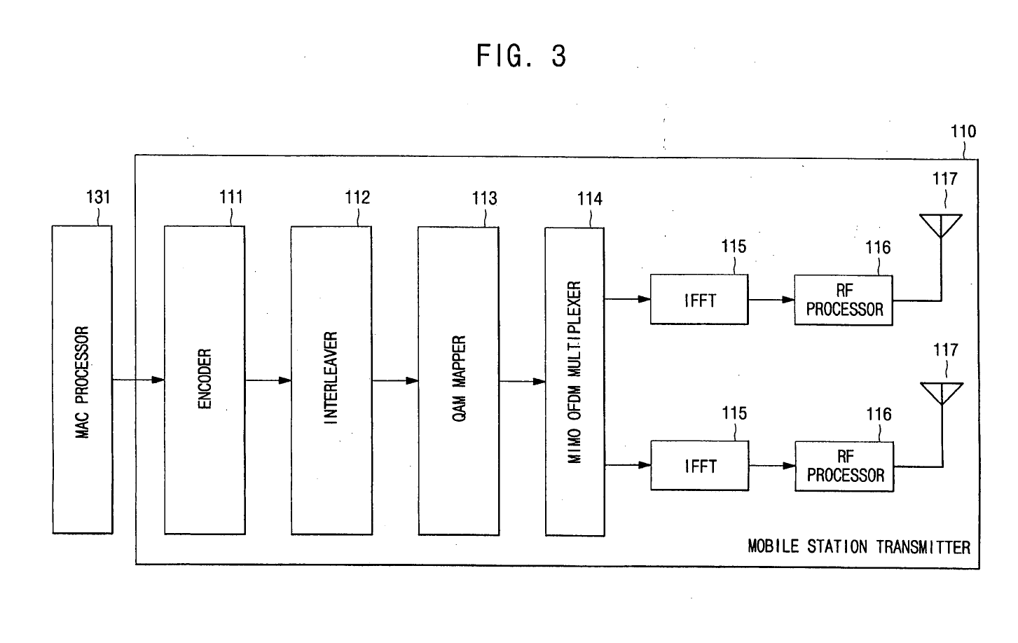

FIG. 3 is a block diagram of a transmitter of an MIMO mobile station according to an exemplary embodiment of the present invention.

As illustrated in FIG. 3, a transmitter 110 of an MIMO mobile station may comprise an encoder 111, an interleaver 112, a Quadrature Amplitude Modulation (QAM) mapper 113, an MIMO Orthogonal Frequency Division Multiplexing (OFDM) multiplexer 114, Inverse Fast Fourier Transformers (IFFTs) 115, radio frequency (RF) processors 116 and antennas 117. The mobile station transmitter 110 according to an exemplary embodiment of the present invention includes 2 each of the IFFTs 115, the RF processors 116 and the antennas 117.

The encoder 111 serves to encode data received from a Media Access Control (MAC) processor 131 using at least one encoding technique. The encoding technique may be determined by a user, a wireless LAN network standard, and so on. The encoder 111 of the present invention can encode data using a convolution code; a turbo code, which are forward error correction codes, or a Cyclic Redundancy Check (CRC) code, which is a forward error detection code.

The interleaver 112 serves to receive and interleave bits encoded by the encoder 111. In the interleaving process, a sequence of data streams is rearranged in predetermined units to readily restore bits of a data stream successively lost due to momentary noise.

The QAM mapper 113 receives and maps the interleaved bit data using a QAM technique to generate a data symbol. In the present invention, a data symbol is generated by mapping data using the QAM technique, but Quadrature Phase Shift Keying (QPSK), M-ary Phase Shift Keying (MPSK), etc., may be used as a mapping technique.

The MIMO OFDM multiplexer 114 serves to multiplex a pilot symbol, i.e., pilot data, and the data symbol. In a wireless LAN network, Frequency-Division Multiple Access (FDMA), Time-Division Multiple Access (TDMA), Code Division Multiple Access (CDMA), etc., may be generally used to multiplex the symbols. The multiplexed streams are transferred to the Inverse Fast Fourier Transformers (IFFTs) 115, respectively. Each of the IFFTs 115 receives the multiplexed streams one by one and transforms the received streams into the time domain signals by using the inverse Fourier transforming. The OFDM streams transformed into the time domain signals are transferred to the RF processors 116 and the antennas 117 and transmitted to a base station, such as an access point.

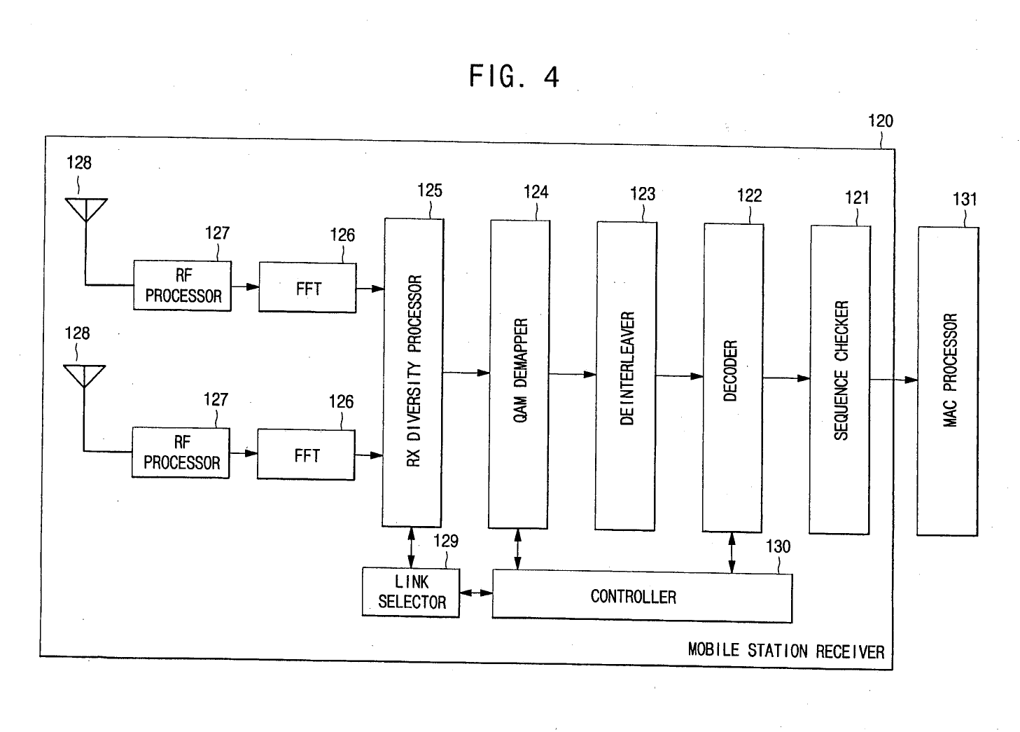

FIG. 4 is a block diagram of a receiver of an MIMO mobile station according to an exemplary embodiment of the present invention.

As illustrated in FIG. 4, a receiver 120 of an MIMO mobile station may comprise a sequence checker 121, a decoder 122, a deinterleaver 123, a QAM demapper 124, a Receiver (RX) diversity processor 125, Fast Fourier transformers (FFTs) 126, RF processors 127, antennas 128, a link selector 129, and so on.

The two antennas 128 receive RF signals from respective access points 10 and 20, and the received RF signals are converted into OFDM streams by the RF processors 127. The converted OFDM streams are input into the FFTs 126. The FFTs 126 transform the received OFDM streams into data symbols and transfer the data symbols to the RX diversity processor 125.

The RX diversity processor 125 performs a diversity process on the plurality of symbol streams and then transfers the symbol streams to the QAM demapper 124. The QAM demapper 124 demaps the transferred symbol streams, thereby restoring data bits. In the present invention, the QAM technique is used, but QPSK, MPSK, etc., may also be used, as in the transmitter 110 of a mobile station.

The restored data bits are deinterleaved by the deinterleaver 123 and then transferred to the decoder 122. The decoder 122 decodes the deinterleaved data bits, thereby converting them into data.

The sequence checker 121 according to the present invention analyzes the decoded data to check a sequence of the data and drops repeatedly received data. The mobile station 100 according to the present invention receives data through two antennas, and the same data may be repeatedly received from first and second base stations. The operation of the sequence checker 121 is for coping with such repeatedly received data. It is described that the sequence check process is performed after the decoding process, but the present invention is not limited thereto.

Meanwhile, the link selector 129 of FIG. 4 measures a received signal strength, a strength of a response, noise distribution, etc., according to respective links and selects a link providing a better communication environment according to the measured results. When the link providing a better environment is selected, a controller 130 controls a connection close message to be transmitted to an access point corresponding to an unselected link.

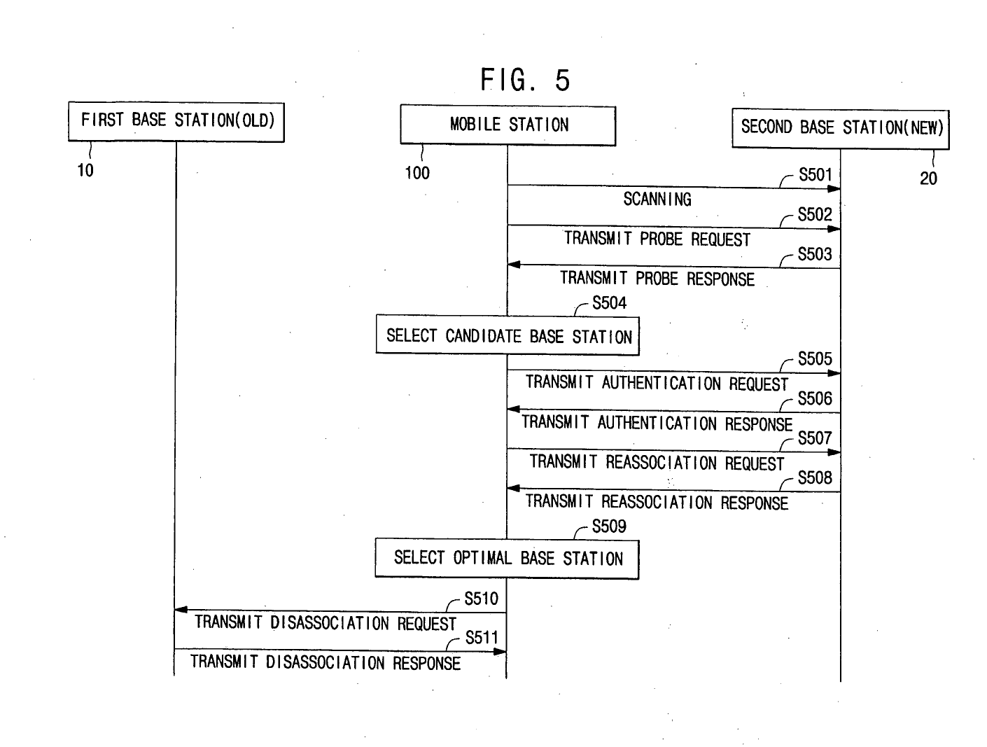

FIG. 5 is a flowchart showing a method of controlling handoff in a wireless LAN network according to an exemplary embodiment of the present invention.

A mobile station 100 scans a neighboring base station using one of MIMO antennas (step 501). When a base station is detected by the scanning operation, the mobile station 100 may obtain information on channel state, signal intensity, etc., of the detected base station by exchanging a probe request message and a probe response message with the detected base station (steps 502 and 503). In the exemplary embodiment of FIG. 5, it is assumed that the mobile station 100 detects a second base station 20 alone.

Subsequently, the mobile station 100 selects a candidate base station to which the mobile station 100 can perform handoff using the obtained information (step 504). Such a candidate base station selection process is for when at least two base stations are detected in step 501 by the scanning operation.

When the second base station 20 alone is detected by the scanning operation, as illustrated in FIG. 5, the mobile station 100 may skip a communication environment comparison process and directly select the second base station 20 as the candidate base station.

Subsequently, the mobile station 100 exchanges an authentication request message and an authentication response message with the second base station 20 (steps 505 and 506) and exchanges a reassociation request message and a reassociation response message with the second base station 20 (steps 507 and 508), thereby establishing a new link with the second base station 20.

In this way, through steps 501 to 508, the mobile station 100 maintains a link with the previously connected first base station 10 using a remaining antenna. Needless to say, the mobile station 100 can transmit and receive data transmitted from a core network through the maintained link.

After establishing the new link, the mobile station 100 selects an optimal base station using the information on channel state and signal intensity of the first and second base stations 10 and 20 (step 509).

The exemplary embodiment of FIG. 5 shows a case in which the second base station 20 to which the new link is established is determined as the optimal base station in step 509. The mobile station 100 closes a link with an unselected base station. In FIG. 5, the mobile station 100 closes the link with the first base station 10, which may be implemented by exchanging a disassociation request message and a disassociation response message (steps 510 and 511).

Meanwhile, in steps 508 to 510 of the handoff control process, the mobile station 100 may receive the same data from the first and second base stations 10 and 20. In this case, the mobile station 100 may select and process the one from the repeatedly received data.

To this end, the mobile station 100 may use a sequence of received packets. The mobile station 100 temporarily stores a sequence of packets received from the base stations 10 and 20, and when a packet of the temporarily stored sequence is received again afterwards, may control the packet to be dropped.

According to the inventive system and method for controlling handoff in a wireless LAN network, soft handoff is performed using an MIMO system to maintain a connection with a previous base station while establishing a link with a new base station. Consequently, it is possible to prevent packet transmission delay and packet loss that may be caused by handoff.

While the present invention has been described with reference to exemplary embodiments thereof, it will be understood by those skilled in the art that various changes in from and detail may be made therein without departing from the scope of the present invention as defined by the following claims.

What is claimed is:

1. A wireless local area network (LAN) network, comprising:
a first base station transmitting and receiving data packets to and from a mobile station existing in an area managed by the first base station;
a second base station performing a soft handoff process with the mobile station entering an area managed by the second base station; and
the mobile station performing handoff to the second base station while receiving packets from the previously connected first base station using a Multi-Input Multi-output (MIMO) system,
wherein said mobile station measures intensities of signals from said first base station and said second base station and selects either said first base station or said second base station based on signal strength.

2. The wireless LAN network of claim 1, wherein the mobile station comprises:
a mobile station transmitter for generating a plurality of symbols corresponding to data to transmit and multiplexing the generated symbols and outputting the symbols through a plurality of antennas; and
a mobile station receiver for receiving symbols in parallel through a plurality of antennas and demodulating the respective received symbols.

3. The wireless LAN network of claim 2, wherein the mobile station receiver includes:
a link selector for measuring intensities of respective signals received through the plurality of antennas and selecting abase station transmitting a strongest signal from the measured signals.

4. The wireless LAN network of claim 2, wherein the mobile station receiver comprises:
a sequence checker for checking a sequence of data received from the first and second base stations, and when repeated data is received, dropping the repeated data.

5. A mobile station in a wireless local area network (LAN) network, comprising:
a mobile station transmitter for generating a plurality of symbols corresponding to data to transmit and multiplexing the generated symbols and outputting the symbols through a plurality of antennas; and
a mobile station receiver for receiving symbols in parallel through a plurality of antennas and demodulating the respective received symbols.

6. The mobile station of claim 5, wherein the mobile station transmitter comprises:
an encoder for encoding data received from a Media Access Control (MAC) processor using at least one encoding technique;
a Quadrature Amplitude Modulation (QAM) mapper for mapping the bit data encoded by the encoder using a QAM technique to generate a data symbol;
a multiplexer for multiplexing a pilot symbol and the data symbol;
a plurality of inverse Fourier transformers for receiving the multiplexed streams and transforming the received streams into the time domain signals using the inverse Fourier transforming; and
a radio frequency (RF) processor for RF-processing the signals transformed into the time domain signals.

7. The mobile station of claim 5, wherein the mobile station receiver comprises:
a plurality of radio frequency (RF) processors for RF-processing signals received through the plurality of antennas;
a plurality of Fourier transformers for Fourier-transforming the RF-processed signals to generate a plurality of data symbols according to the received RF signal;
a Receiver (RX) diversity processor for performing a diversity process on the plurality of data symbols;
a Quadrature Amplitude Modulation (QAM) demapper for demapping the diversity-processed data symbols using a QAM technique to generate a bit stream; and
a decoder for decoding the bit stream generated by the QAM demapper according to at least one encoding technique.

8. The mobile station of claim 7, further comprising:
a link selector for measuring intensities of the respective signals received through the plurality of antennas and selecting a base station transmitting a strongest signal from the measured signals.

9. The mobile station of claim 8, wherein the link selector controls a link with an unselected base station to be closed.

10. The mobile station of claim 7, further comprising:
a sequence checker for checking a sequence of data received from a plurality of base stations, and when repeated data is received, dropping the repeated data.

11. A method of controlling handoff in a wireless local area network (LAN) network, comprising the steps of:
transmitting and receiving, at a mobile station, a data packet to and from a currently connected first base station using a first antenna;
scanning, at the mobile station, an adjacent base station using a second antenna and establishing a link with a second base station detected by the scanning operation; and
after establishing, at the mobile station, the new link, comparing communication environments of the first and second base stations and selecting a base station providing a better communication environment.

12. The method of claim 11, further comprising the step of:
after selecting, at the mobile station, a base station providing a better communication environment, closing a link with an unselected base station.

13. The method of claim 11, further comprising the step of:
checking a sequence of data received from the first and second base stations, and when repeated data is received, dropping the repeated data.

14. The method of claim 11, further comprising the step of:
when a plurality of base stations are detected by the scanning operation, checking, at the mobile station, communication environments of the plurality of base stations and establishing a link with a base station providing a optimal communication environment.

15. The method of claim 11, wherein the mobile station obtains information on channel state, and signal intensity of the plurality of base stations by transmitting and receiving messages with the plurality of base stations, and compares the communication environments of the plurality of base stations using the obtained information.

16. A wireless local area network (LAN) network, comprising:
a first base station transmitting and receiving data packets to and from a mobile station existing in an area managed by the first base station;
a second base station performing a soft handoff process with the mobile station entering an area managed by the second base station; and
the mobile station performing handoff to the second base station while receiving packets from the previously connected first base station using a Multi-Input Multi-output (MIMO) system,
wherein said mobile station measures intensities of signals from said first base station and said second base station and selects either said first base station or said second base station based on signal strength including a strength of a response signal and noise distribution.
